(19) United States
(12) Patent Application Publication
(10) Pub. No.: US 2026/0354944 A1
(43) Pub. Date: Nov. 12, 2026

(54) Forming Attachments on Teeth

(71) Applicant: PR Dental Solutions LLC, Frisco, TX (US)

(72) Inventors: Christopher Probst, Frisco, TX (US); Jiaying Ren, Frisco, TX (US)

(73) Assignee: PR Dental Solutions LLC, Frisco, TX (US)

(21) Appl. No.: 19/201,129

(22) Filed: May 7, 2025

(51) Int. Cl. A61C 8/00

(52) U.S. Cl. CPC A61C 8/009

(57) ABSTRACT

In a general aspect, a dental appliance includes an attachment template that is configured to be applied to teeth of a patient. The attachment template has a recessed surface that defines recesses and a well in a target recess. The recesses fit over respective teeth of the patient, and the target recess fits over a target tooth that is intended to receive an attachment. The well is located in the target recess such that, when the target tooth resides in the target recess, the well resides at a position that matches a target location of the attachment on a surface of the target tooth. The dental appliance also includes a covering body with a mating surface configured to mate with the recessed surface of the attachment template. The mating surface includes a covering portion that covers the opening of the well when the mating surface mates with the recessed surface.

### BACKGROUND

The following description relates to forming attachments on teeth.

Misaligned teeth can impact cosmetics and the health and functionality of an individual's mouth. For example, misaligned teeth can create discomfort during chewing, cause uneven wear of teeth, increase the risk of gum disease, and possibly hinder the formation of speech. Misaligned teeth, however, can often be treated using orthodontic techniques that reposition the teeth, thereby improving cosmetic appearance and oral function.

### DESCRIPTION OF DRAWINGS

FIG. 1 is a schematic diagram, in perspective view, of an example set of attachments that have been positioned and formed on target teeth of a patient's dentition;

FIG. 2A is a schematic diagram, in exploded view, of an example dental appliance that includes an attachment template and a covering body;

FIG. 2B is a schematic diagram, in assembled view, of the example dental appliance of FIG. 2A;

FIG. 2C is a schematic diagram, in perspective view, of the attachment template of FIG. 2A;

FIG. 2D is a schematic diagram, in cross-section view, of a recess of the example dental appliance of FIG. 2A where a well is not present;

FIG. 2E is a schematic diagram, in cross-section view, of a target recess of the example dental appliance of FIG. 2A where a well is present;

FIG. 2F is a schematic diagram, in cross-section view, of the target recess of FIG. 2E but in which the covering body includes a portion that extends along an outer well surface of a well;

FIG. 2G is a schematic diagram, in cross-section view, of the target recess of FIG. 2E, but in which a portion of the covering body adjacent the target recess is configured to include one or more channels;

FIG. 3A is a schematic diagram, in perspective view, of an example dental appliance that includes a covering body configured to have a tape structure;

FIG. 3B is a schematic diagram, in perspective view, of the covering body of FIG. 3A;

FIG. 3C is a schematic diagram, in side view, of the covering body of FIG. 3A;

FIG. 3D is a schematic diagram, in cross-section view, of the covering body of FIG. 3A covering an opening of a well in an attachment template;

FIG. 4 is a schematic diagram, in perspective view, of an example dental appliance in which a covering body is configured to wrap around a pair of target recesses;

FIG. 5 is a flowchart showing an example dental method for forming attachments on a dentition of a patient.

### DETAILED DESCRIPTION

In a general aspect, dental appliances are described for forming attachments on teeth. Such formation may also include positioning the attachments on the teeth. The dental appliances include an attachment template that is configured to be applied to teeth of a patient. A recessed surface of the attachment template defines recesses that are configured to fit over respective teeth of the patient. The recesses include a target recess that is configured to fit over a target tooth. The target tooth is part of the respective teeth and intended to receive an attachment. The recess surface of the attachment template also defines a well in the target recess. The well is located in the target recess such that, when the target tooth resides in the target recess, the well resides at a position that matches a target location of the attachment on a surface of the target tooth. The well includes an opening and an inner well surface. The dental appliances also include a covering body that has a mating surface configured to mate with the recessed surface of the attachment template. The mating surface includes a covering portion that covers the opening of the well when the mating surface mates with the recessed surface. The covering portion and the inner well surface enclose a fill volume when the mating surface mates with the recessed surface, and this fill volume matches a target shape and a target size of the attachment.

Orthodontic treatment techniques are often employed to reposition teeth, thereby enhancing the cosmetic appearance of a patient, optimizing the functionality of the teeth during mastication, and improving the patient's oral health. These techniques may rely on devices to apply forces to teeth to move them into an optimal set of positions along a dental arch. For example, an orthodontic treatment technique may use brackets, such as those formed of metal or ceramic materials, that are semi-permanently bonded to the target teeth of a patient using a hardenable adhesive. The brackets are each mechanically coupled to a wire via elastic ligatures, and the wire, when placed in tension, selectively applies forces through the brackets to the target teeth to displace them towards respective target positions. During a treatment period, the wire and elastic ligatures may be replaced and adjusted in an iterative manner to generate new sets of forces that iteratively displace the target teeth toward their final target positions. The brackets are then removed from the target teeth once the treatment period is over.

Orthodontic treatment techniques, however, have increasingly moved towards the use of removable aligner devices. These devices are configured to conformally fit over the teeth of a dental arch. Moreover, the devices can be selectively detached from and reattached to the teeth as needed. This removable aspect allows the aligner devices to be easily replaced during a treatment period. For example, the removable aligner devices may correspond to a series of such devices that are successively placed in service and replaced according to a predetermined schedule, such as during an office visit or at a patient's residence. Each aligner device applies a respective set of forces to the teeth of a dental arch such that the series successively displaces the teeth toward final target positions over the treatment period. The removable aspect of the aligner devices may also provide benefits to a patient, such as by allowing the patient to alleviate a temporary oral discomfort or by facilitating the cleaning of teeth. In addition to being removable, the aligner devices are often formed of a clear thermoplastic material (e.g., a polyurethane compound) whose transparent nature allows the devices to appear virtually invisible when worn by a patient. However, the thermoplastic material—while being flexible to allow the removable aspect of the aligner devices—may also result in configurations of the devices where they are unable to apply a desired force, torque, or both to one or more target teeth. Orthodontic treatment techniques therefore often complement the use of the removable aligner devices with attachments that are formed on one or more target teeth of a patient's dentition. The attachments protrude from the surface of a target tooth (e.g., a buccal surface) and thus provide an additional structure that the devices can engage. The enhanced contact allows the removable aligner devices to more effectively apply force, torque, or both to the one or more target teeth.

In some implementations, the dental appliances described herein provide improvements and advantages over existing appliances and their methods of use. For example, the dental appliances described herein can prevent the well of an attachment template from being improperly filled with precursor material, such as by underfilling or overfilling the wells. A proper amount of the precursor material is thus delivered to the target teeth of a patient. Such precise delivery allows attachments to be formed on the target teeth not only at their desired locations, but also at their desired shapes and sizes. Other improvements and advantages may be achieved in some cases. The improvements and advantages of the dental appliances are described further below.

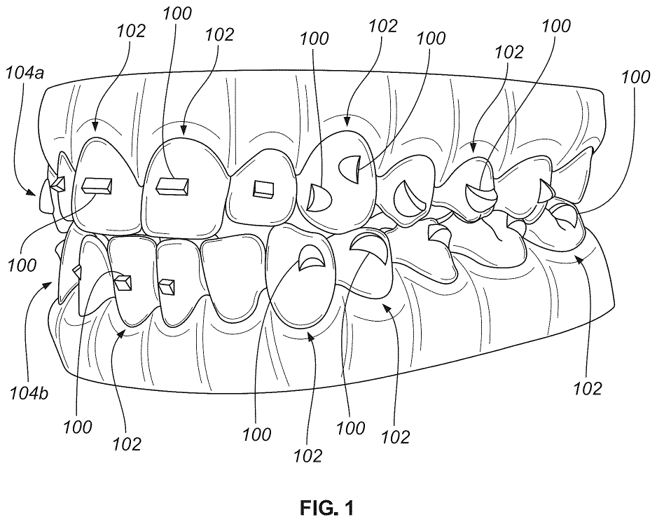

FIG. 1 presents a schematic diagram, in perspective view, of an example set of attachments 100 that have been formed on one or more target teeth 102 of a patient's dentition 104. The dentition 104 may correspond to a group of teeth that are associated with a dental arch of the patient. For example, the group of teeth may correspond to a type of teeth (e.g., molar teeth), an arrangement of teeth (e.g., neighboring pairs of canine and lateral teeth), or some other group of teeth. FIG. 1 illustrates two dentitions 104a, 104b that are associated with different, respective removable aligner devices. The first dentition 104a corresponds to a first group of teeth on an upper dental arch (e.g., a maxillary arch), and the second dentition 104b corresponds to a second group of teeth on a lower dental arch (e.g., a mandibular arch). In this illustration, the first and second dentitions 104a, 104b include all teeth of their respective dental arches. However, other numbers of teeth are possible (e.g., a half portion of a dental arch). Moreover, the teeth need not be contiguous (e.g., due to missing teeth). In certain cases, only a single dentition 104 is present.

FIG. 1 depicts the example set of attachments 100 as having nineteen attachments 102 that are distributed over eighteen target teeth 102. However, other configurations are possible for the example set of attachments 100. For instance, FIG. 1 shows the example set of attachments 100 as residing on an outward-facing surface of a target tooth 102 (e.g., a buccal surface or a labial surface). However, in certain configurations, the example set of attachments 100 may include one or more attachments 102 on an inward facing surface of a target tooth 102 (e.g., a lingual surface).

In many cases, an orthodontic practitioner determines the configuration of the example set of attachments 100 as part of developing a treatment plan for the patient. For example, the orthodontic practitioner may identify teeth of the dentition 104 (e.g., target teeth) that require attachments, such as by using a computer model of the dentition 104. In FIG. 1, each of the two dentitions 104a, 104b have target teeth 102. However, it is possible for attachments to be present on only a single dentition. The orthodontic practitioner may also determine the characteristics of one or more attachments 100 for each of the identified target teeth 102. Such characteristics may include, for example, the number of attachments for a target tooth, their respective positions on the target tooth, and their respective shapes and sizes. As such, each attachment 100 may have a unique combination of location, shape, and size. The characteristics may allow a removable aligner device to apply an optimal set of forces to each target tooth 102 during its period of service.

To form the example set of attachments 100 on their target teeth 102, the bonding surfaces of the target teeth 102 may be rinsed with water and subsequently dried in a stream of air. The bonding surfaces may then undergo a chemical treatment process that includes applying an etchant to the bonding surfaces (e.g., an etchant based on a phosphoric acid solution or gel). The etchant is removed after a predetermined time by rinsing the bonding surfaces with water, and the etched and rinsed bonding surfaces are then dried in a stream of air. In certain cases, the chemical treatment process also includes applying a bonding primer or adhesive to the bonding surfaces to prepare them for bonding with a composite resin material. This application may involve curing the bonding primer or adhesive, such as by exposure to optical radiation. The bonding surfaces of the target teeth 102 are then subsequently dried in a stream of air.

After the chemical treatment process is completed, a formation process may be used to form the example set of attachments 100 on the target teeth 102. The formation process includes obtaining an attachment template that includes a well for each attachment 100. The formation process also includes filling each well in the attachment template with a precursor material that is configured to flow like a fluid but harden into a composite resin material when exposed to optical radiation (e.g., ultraviolet light). After each well is filled, the attachment template is then placed onto the dentition 104, thereby positioning the wells adjacent their respective target teeth 102. Such positioning allows the precursor material in each well to contact the bonding surface of a target tooth 102. In many cases, each well is associated with a single target tooth 102, and when placed against this tooth, the well defines a target shape and size for its attachment 100. Moreover, the attachment template is configured such that, when placed on the dentition 104, the well resides adjacent its target tooth 102 and at a position matching a target location for its attachment 100 on the target tooth 102.

To form the example set of attachments 100, the precursor material in each well is exposed to the optical radiation, thereby hardening into the composite resin material. Such exposure may occur on an individual basis during the formation process, and in some cases, according to a sequence. The attachment template is transparent to the optical radiation, and the optical radiation may be generated using an optical source, such as a handheld laser device. In these cases, exposing the precursor material includes transmitting the optical radiation from the optical source, through the attachment template (e.g., through a wall defining a well), and to the precursor material. The formation process additionally includes removing the attachment template from the dentition 100 after the precursor material has hardened into the composite resin material. In doing so, the example set of attachments 100 are exposed and the dentition 100 becomes ready to receive a removable aligner device.

Conventional attachment templates, however, do not prevent the wells from being improperly filled, such as by underfilling or overfilling a well. These templates are therefore prone to user error in which an attachment is formed with a shape and size that deviates from that specified by an orthodontic treatment plan. Such deviation may also result in the attachment having a location that is offset from that specified by the orthodontic treatment plan.

For example, a user of an attachment template may inadvertently underfill a well with the precursor material, resulting in the precursor material making poor contact with a target tooth when the attachment template is placed on the dentition. The attachment, when formed, may therefore have a weak bond to the target tooth and thus have an increased risk of breaking off during service. The attachment may also have a shape and a size that prevents a removable aligner device from properly engaging the attachment. This improper engagement may result in the aligner device applying suboptimal or incorrect forces to the target tooth. The improper engagement may also result in the aligner device altering forces that would otherwise be applied to other teeth in the dentition.

As another example, a user of the attachment template may inadvertently overfill a well with the precursor material, resulting in excess precursor material on a target tooth when the attachment template is placed on the dentition. The attachment, when formed, may therefore have excess material (e.g., flash material) on the bonding surface of the target tooth, such as along a perimeter of the attachment on the bonding surface. This excess material may prevent a removable aligner device from properly contacting the target tooth. The attachment may also have a shape and a size that prevents the aligner device from properly engaging the attachment. Like with an underfilled well, this improper engagement may result in the aligner device applying suboptimal or incorrect forces to the target tooth. The improper engagement may also result in the aligner device altering the forces that would otherwise be applied to other teeth in a dentition.

Improperly formed attachments can negatively impact a patient's progress on an orthodontic treatment plan. For example, improperly formed attachments may cause inadequate or incorrect tooth displacement during treatment, thereby requiring the patient to undergo subsequent corrective measures. Such measures can extend the treatment time of the patient as well as increase the treatment costs. Improperly formed attachments may also reduce the predictability of the patient's tooth displacement, requiring the orthodontic practitioner to invest additional time in revising the orthodontic treatment plan. If discovered, improperly formed attachments can be altered (e.g., via grinding, polishing, adjusting, etc.) to correct deficiencies in shape and size. In certain cases, an improperly formed attachment may even be removed from its target tooth and then reformed.

However, such post-processing of the attachments increases the time, effort, and cost associated with the patient's orthodontic treatment plan.

In a general aspect, dental appliances are described herein that minimize or eliminate user errors that can occur when filling the wells of an attachment template. The dental appliances include an attachment template and a covering body that, when mated together, enclose a fill volume for each attachment that defines a target shape and a target size for the attachment. The fill volume may be pre-filled with precursor material, such as during the manufacture of the dental appliances, or may be filled with precursor material by a user, such as during an office visit by the patient. In enclosing the fill volume, the attachment template and the covering body precisely control the amount of precursor material occupying a well. Thus, when the covering body is removed from the attachment template and the attachment template is subsequently placed on the patient's dentition, a proper amount of precursor material contacts the target tooth. Moreover, the attachment can be formed on the target tooth at the target location and with the target shape and size.

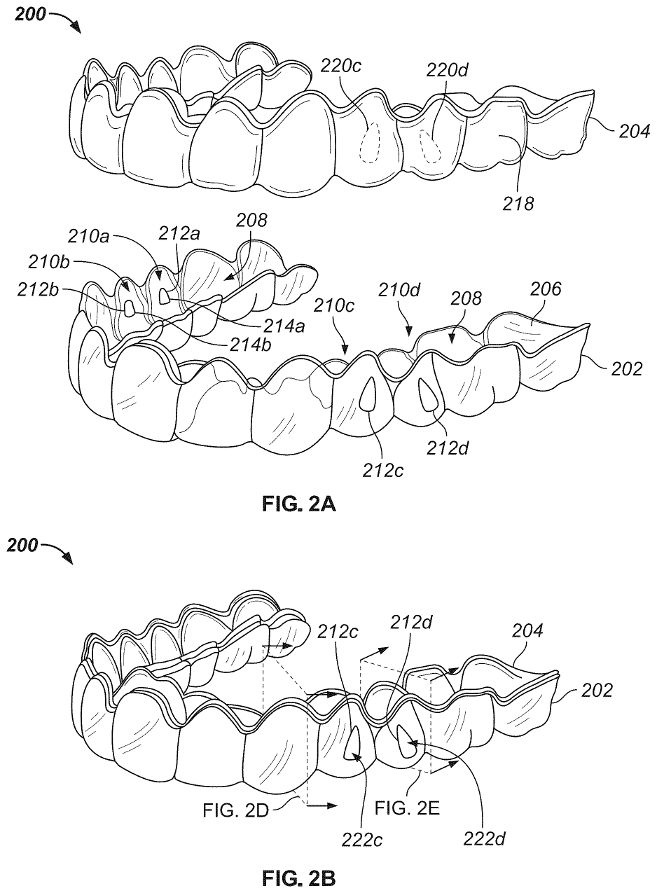

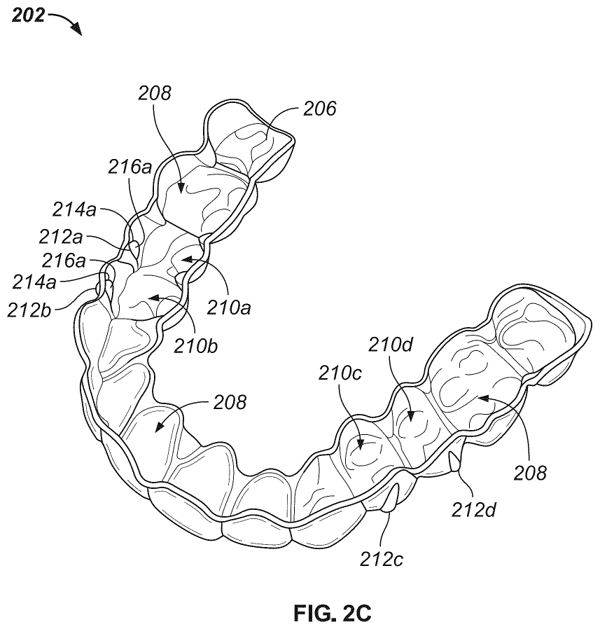

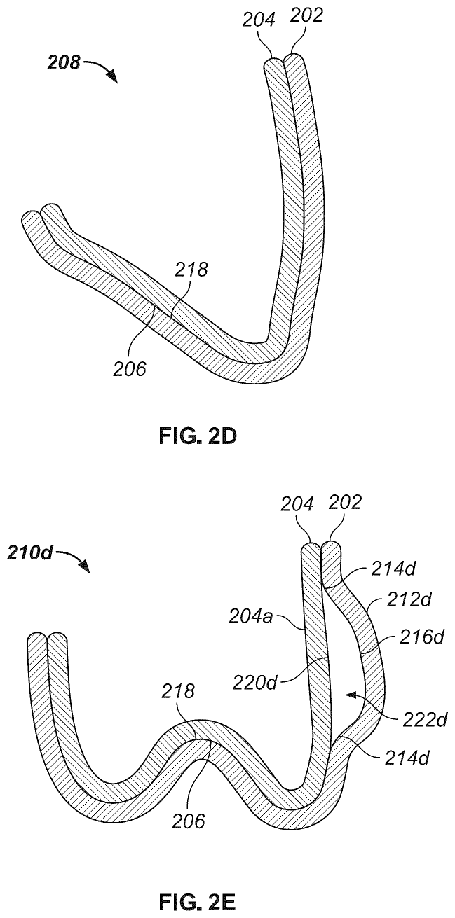

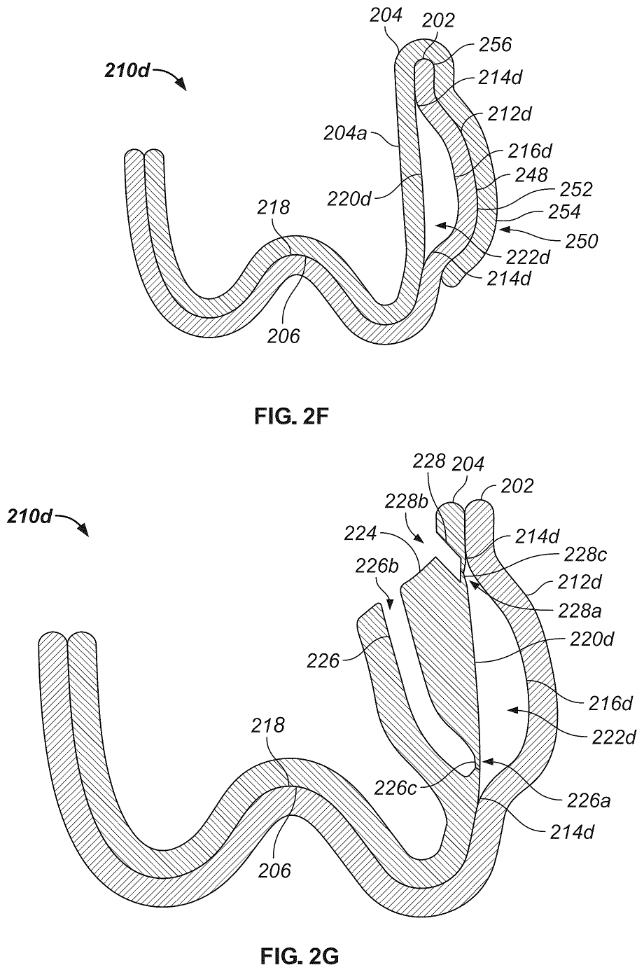

Now referring to FIG. 2A, a schematic diagram is presented, in an exploded view, of an example dental appliance 200 that includes an attachment template 202 and a covering body 204. FIG. 2B presents an assembled view of the example dental appliance 200, and FIG. 2C presents a perspective view of the attachment template 202. The attachment template 202 is configured to be applied to teeth of a patient. Moreover, the attachment template 202 has a recessed surface 206 that defines recesses 208 in the attachment template 202. The recesses 208 are configured to fit over respective teeth of the patient, and the respective teeth may, for example, define part or all of a dentition of the patient. This dentition may be analogous to the dentition 104 described in relation to FIG. 1. The respective teeth include a target tooth that is intended to receive an attachment, and the recesses 208 include a target recess 210 that is configured to fit over the target tooth.

FIGS. 2A-2C depict the attachment template 202 as having four target recesses 210a-d that are associated with respective target teeth of an upper dental arch (e.g., premolar teeth 4-5 and 12-13 of a maxillary arch). However, other numbers and associations are possible for the target recesses 210, including a different dental arch (e.g., a lower dental arch, such as a mandibular arch). Moreover, FIGS. 2A-2C depict the attachment template 202 as extending along the entirety of the upper dental arch. However, other extension lengths and locations are possible. For example, the attachment template 202 may be configured to extend along only a portion of the dental arch, such as along the posterior teeth of the upper dental arch. In these cases, the dentition of the patient may correspond to a particular group of teeth, such as described previously for the dentition 104 of FIG. 1.

The attachment template 202 also includes a well 212 located in the target recess 210 such that, when the target tooth resides in the target recess 210, the well 212 resides at a position that matches a target location of the attachment on a surface of the target tooth. In FIGS. 2A-2C, four wells 212a-d are shown for, respectively, the target recesses 210a-d. However, other numbers of wells 212 are possible, including multiple wells for a single target recess. The well 212 includes an opening 214 and an inner well surface 216. In many cases, the opening 214 contacts the surface of the target tooth when the attachment template 202 is placed on the dentition of the patient. In doing so, the opening 214 may help to define a perimeter of the attachment on the surface of the target tooth. Moreover, the inner well surface 216 may help to define a target shape and a target size of the attachment. FIG. 2D presents a schematic diagram, in cross section view, of an example opening 214d and an example inner well surface 216d for the well 212d.

The covering body 204 has a mating surface 218 that is configured to mate with the recessed surface 206 of the attachment template 202. In certain cases, such mating may include the mating surface 218 conformally contacting the recessed surface 206. For example, FIG. 2D presents a schematic diagram, in cross-section view, of a recess 208 where a well is not present. The example dental appliance 200 is assembled, and the mating surface 218 of the covering body 204 mates against the recessed surface 206 of the attachment template 202. The mating surface 218 conformally contacts the recessed surface 206. However, in other cases, such mating leaves a gap between the mating surface 218 and the recessed surface 206. FIG. 2E presents a schematic diagram, in cross-section view, of the target recess 210d where the well 212d is present. The mating surface 218 does not conformally contact a portion of the recessed surface 206 in the vicinity of the well 212d, but rather, leaves a gap that can provide a fill volume for containing a precursor material. When present, the precursor material may occupy greater than 90% of the fill volume. In many cases, the precursor material occupies 100% of the fill volume to fully occupy the fill volume.

In many implementations, the mating surface 218 includes a covering portion 220 that covers the opening 214 of the well 212 when the mating surface 218 mates with the recessed surface 206. The mating surface 218 includes a covering portion 220 for each well 212 of the attachment template 204. For example, the mating surface 218 may include four covering portions 220a-d for, respectively, the wells 212a-d. The covering portion 220 and the inner well surface 216 enclose a fill volume 222 when the mating surface 218 mates with the recessed surface. The fill volume 222 matches a target shape and a target size of the attachment for the target tooth. FIG. 2E presents an example fill volume 222d for well 212d that is formed when the mating surface 218 of the covering body 204 mates with the recessed surface 206 of the attachment template 202. The covering portion 220d of the mating surface 218 covers the opening 214d of the well 212d, and along with the inner well surface 216d of the well 212d, encloses the example fill volume 222d. The fill volume 222d can thus define a target shape and a target size for an attachment that is intended for the target tooth of the target recess 210d. Moreover, when the covering body 204 is removed from the attachment template 202, a portion of the mating surface 218 facing the well 212d may slide along a portion of the recessed surface 206 adjacent to (e.g., surrounding) the inner well surface 216d. This shear-like motion may reduce the risk that precursor material occupying the fill volume 222d may get pulled out of the well 212d in part or in whole when the covering body 204 is removed, such as due to sticking to the covering portion 220d of the mating surface 218.

The example dental appliance 200 is configured to be used with a precursor material that flows like a fluid, but in response to optical radiation (e.g. ultraviolet light), can harden or cure into a solid body, thus forming a composite resin material. The precursor material occupies each fill volume 222, and when hardened or cured in contact a target tooth, forms a body of the attachment for the target tooth. In some implementations, the precursor material includes a flowable, radiation-curable resin material with a ceramic filler material therein. Examples of the precursor material include SureFil SDR® flow+product line from Dentsply Sirona, Inc. and the Tetric® product line from IvoClar Vivadent AG.

In some implementations, the example dental appliance 200 includes one or more coatings that modify an adhesion of the precursor material to a surface of the attachment template 202, a surface of the covering body 204, or both. Such coatings may minimize or eliminate the risk of the precursor material being pulled out of a well 212 when the covering body 204 is removed from the attachment template 202. For example, the attachment template 202 may include a release coating on the inner well surfaces 216 of the wells 212. The release coating is configured to prevent the precursor material from bonding to the attachment template 202 when exposed to the optical radiation. Examples of the release coating include coatings formed of a silicone material, a perfluorocarbon material, a polyethylene material, and a paraffin material. As another example, the covering body 204 may include a non-stick coating on the covering portion 220 of the mating surface 218. The non-stick coating is configured to prevent the precursor material from adhering to the covering body 204. The non-stick coating may be formed of materials that are similar to the release coating. However, in some cases, the non-stick coating is formed of materials that are different than the release coating.

In some implementations, the attachment template 202 is transparent to the optical radiation used to produce the composite resin material from the precursor material. For example, the attachment template 202 may be formed a clear polymeric material, such as a polyurethane thermoplastic material. In some implementations, the covering body 204 is transparent to the optical radiation. For example, the covering body 204 may also be formed a clear polymeric material (e.g., a polyurethane thermoplastic material. However, in other implementations, the covering body 204 is opaque to the optical radiation. In these implementations, the covering body 204 may be formed, in whole or in part, of a material that is opaque to the optical radiation. For example, the material may be a polyaromatic plastic material (e.g., PEEK). As another example, the material may be a polymeric material that includes an opacifier (e.g., titanium dioxide). As yet another example, the material may be a multi-layer material in which one of the layers (e.g., an interior layer) is a metal layer, such as an aluminum layer.

In some implementations, the covering body 204 may also be shaped to minimize the risk of the precursor material being pulled out of a well 212 when the covering body 204 is removed from the attachment template 202. For example, and with reference to FIG. 2E, the covering body 204 may include a wall 204a that defines a portion of the mating surface 218 facing the well 212d. This wall 204a may be shaped to slide along a portion of the recessed surface 206 adjacent to (e.g., surrounding) the inner well surface 216d. This shear-like motion of the wall 204a may reduce the risk that the precursor material (or portion thereof) occupying the fill volume 222d gets pulled out of the well 212d when the covering body 204 is removed, such as due to sticking to the covering portion 220d of the mating surface 218.

In some implementations, the mating surface 218 includes a contact portion that contacts the recessed surface 206 of the attachment template 202 when the mating surface 218 mates with the recessed surface 206. In these implementations, the covering body 204 may include an adhesive coating on at least part of the contact portion. The adhesive coating may, for example, assist the covering body 204 in staying attached to the attachment template 202 when the mating surface 218 mates with the recessed surface 206. Examples of the adhesive coating include vinyl-based polymeric coatings, acrylic-based coatings, polyurethane coatings, and cellulose-based coatings. In some configurations, the adhesive coating may surround each covering portion 220 of the mating surface 218. These configurations may allow the adhesive coating to form a seal around each well 212. The seal may prevent gas (e.g., moisture, volatile organic compounds, etc.) from entering or exiting the well 212.

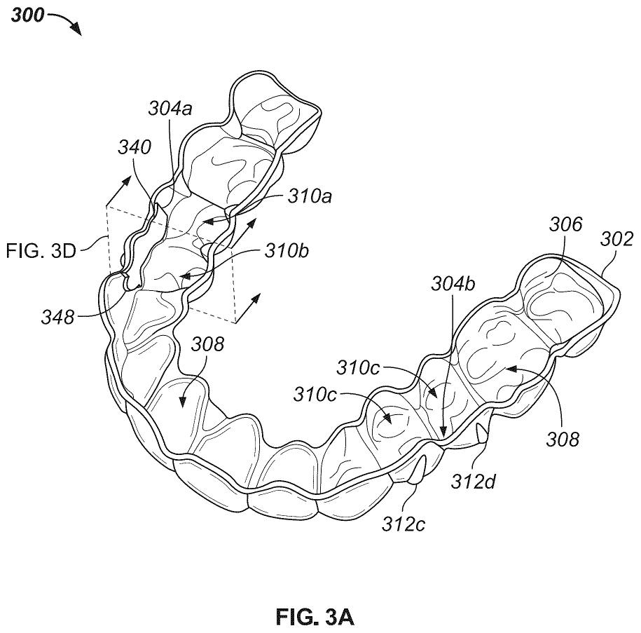

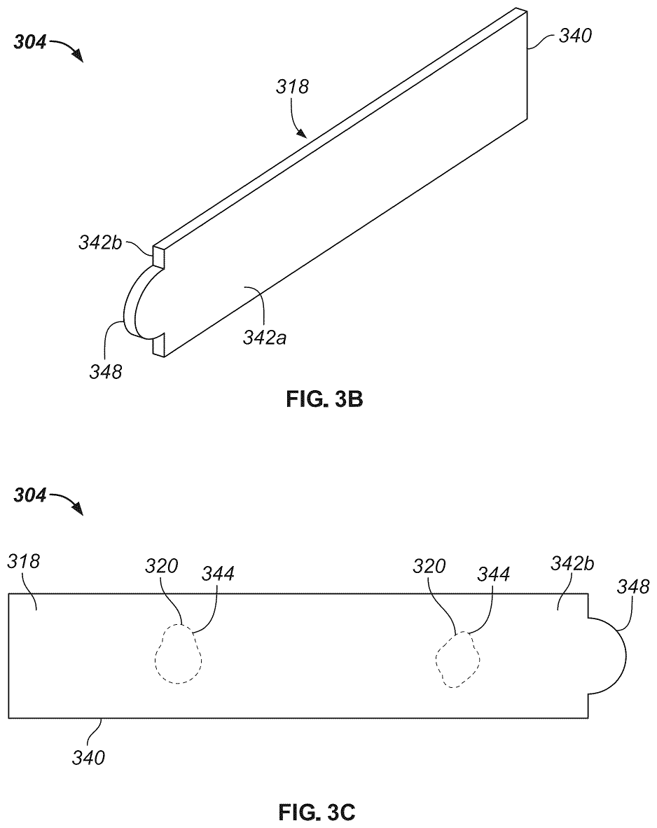

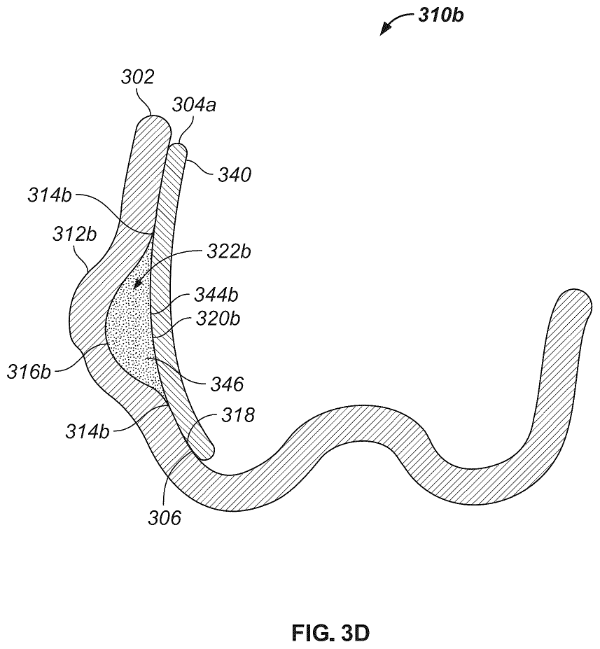

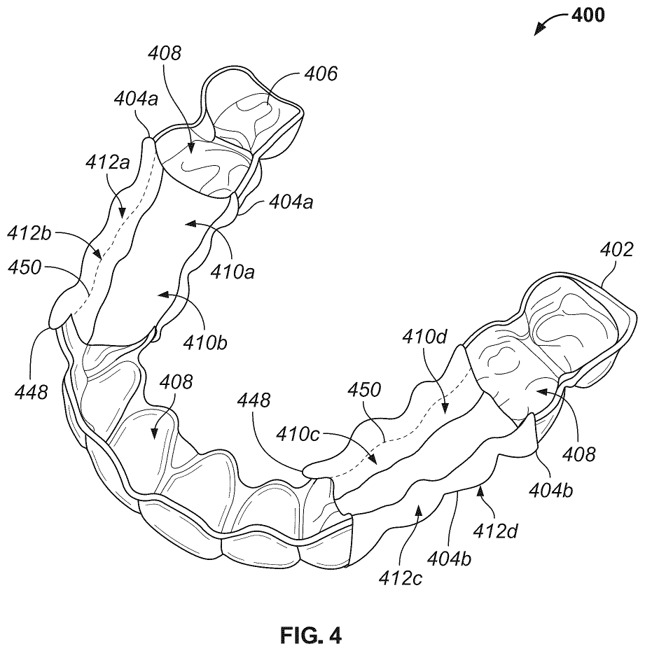

In some implementations, the covering body 204 includes a tab that extends outward from the example dental appliance 200 when the mating surface 218 mates with the recessed surface 206. The tab may allow a user of the example dental appliance 200 to more easily remove the covering body 204 from the attachment template 202. For example, to remove the covering body 204, the user may pull the tab to displace the covering body 204 away from the attachment template 202. In many cases, the tab is a pull tab that provides the user a protruding feature to pull on. Additional examples of the tab are described in relation to FIGS. 3A-4.

In some implementations, such as shown in FIG. 2F, the well 212d includes an outer well surface 248 on an exterior side 250 of the well 212d. The outer well surface 248 and the inner well surface 216d may define a wall 252 of the attachment 202 that is adjacent the fill volume 222d and helps to form a shape and a size of the well 212. In these implementations, the covering body 204 may include a portion 254 that extends over an edge 256 of the wall 252 along the outer well surface 248. The portion 254 may cover (e.g., conformally cover) the outer well surface 248, and in some cases, is configured to serve as a tab. In these cases, the portion 254 may allow a user of the example dental appliance 200 to more easily remove the covering body 204 from the attachment template 202.

Moreover, in implementations where the covering body 204 is opaque to the optical radiation, the portion 254 may prevent light whose wavelength matches the optical radiation from traversing the wall 252 to reach the fill volume 222d (e.g., before covering body 204 is removed from the attachment template 202). In certain cases, the portion 254 and the wall 204a function together to block most or all of such light from reaching the fill volume 222d.

In some implementations, such as shown in FIGS. 2A-2B, the covering body 204 is configured to extend along an entire length of the attachment template 202. As such, the mating surface 218 may mate with an entirety of the recessed surface 206. However, in other implementations, the covering body 204 is configured to extend along only a portion of the attachment template 202. The covering body 204 may also include multiple covering bodies, each extending along a portion of the attachment template 202. For example, the covering body 204 may include first and second covering bodies that extend along different, respective lengths of the attachment template 202. The first covering body may extend along a first length that is associated with the target recesses 210a, 210b, and the second covering body may extend along a second length that is associated with the target recesses 210c, 210d. This configuration of the covering body 204 may provide advantages, such as improving an ease in which the covering body 204 (or portions thereof) is removed from the attachment template 202. Other advantages are possible.

During use, such as during an office visit by the patient, an orthodontic practitioner may obtain the example dental appliance 200 and remove the covering body 204 from the attachment template 202. The example dental appliance 200 may be a filled dental appliance in which each fill volume 222 has been fully pre-filled with a precursor material, such as during manufacture of the example dental appliance 200. Thus, when the covering body 204 is removed from the attachment template 202, a proper amount of the precursor material is present in each well 212, and the orthodontic practitioner is not required to manually fill each well 212 with precursor material. In these configurations, the example dental appliance 200 may mitigate the risk of a user improperly filling the wells 212. In some implementations, the example dental appliance 200 includes a storage container (e.g., a resealable bag) that is opaque to the optical radiation used to harden or cure the precursor material. In these implementations, the orthodontic practitioner may obtain the example dental appliance 200 by removing it from the storage container. The storage container may, in certain cases, be filled with an inert gas (e.g., dry nitrogen, argon, etc.). The inert gas may help prevent the precursor material from being exposed to compounds (e.g., moisture) that might degrade the precursor material.

After removing the covering body 204, the orthodontic practitioner may place the attachment template 202 on the dentition of the patient to receive the patient's teeth into the recesses 208. In doing so, the target teeth of the patient are also received into the target recesses 210 of the attachment template 202, thereby allowing the precursor material in the wells 212 to contact the surfaces of the target teeth. Such contact occurs at the target locations for the target teeth. Moreover, the inner well surfaces 216 define, along with the surfaces of the target teeth, respective volumes for the attachments. These volumes define shapes and sizes for the attachments that, due to the proper amount of precursor material in each fill volume 222, match those specified by an orthodontic treatment plan for the patient. In many implementations, the target shapes and target sizes of the fill volumes 222 correspond to those specified by the orthodontic treatment plan.

After placement of the attachment template 202, the orthodontic practitioner may transmit optical radiation through the attachment template 202 to the precursor material, thereby producing the composite resin material and forming the attachments. This forming process allows the attachments to be formed at their respective target locations while also being simultaneously formed at their respective target shapes and sizes. In many implementations, the attachment template 202 is formed of a material that is transparent to the optical radiation. For example, the optical radiation may correspond to an ultraviolet light, and the attachment template 202 may be formed of a clear polymeric material that transmits the ultraviolet light (e.g., a polyurethane thermoplastic material). The attachment template 202 may also include walls whose thickness is selected to reduce the absorption of the optical radiation.

After the attachments have been formed, the orthodontic practitioner may remove the attachment template 202 from the dentition of the patient, thereby exposing the attachments and placing the dentition in a condition to receive a removable aligner device.

In some implementations, the example dental appliance 200 is configured to allow the orthodontic practitioner to introduce precursor material into the fill volumes 222 without overfilling their wells 212. This configuration of the example dental appliance 200 may be advantageous for precursor materials whose compositions are susceptible to hardening during transport, such as due to exposure to high temperatures. The filling process may be conducted by the orthodontic practitioner on as-needed basis such as, for example, during an office visit by the patient.

FIG. 2G presents a schematic diagram, in cross-section view, of the target recess 210d of FIG. 2E, but in which a portion of the covering body 204 adjacent the target recess 210d is configured to include one or more channels. The covering body 204 includes an exposed surface 224 that resides adjacent the fill volume 222d of the example dental appliance 200 when the mating surface 218 mates with the recessed surface 206. In some instances, the exposed surface 224 faces away from the fill volume 222d. The covering body 204 also includes a channel 226 that extends between first and second channel openings 226a, 226b. The first channel opening 226a is defined by the covering portion 220d of the mating surface 218, and the second channel opening 226b is defined by the exposed surface 224. The channel 226 may be used to introduce the precursor material into the fill volume 222d. To do so, the orthodontic practitioner may obtain a syringe loaded with the precursor material. A needle or a tip of syringe may then be inserted into the second channel opening 226b and a plunger of the syringe displaced to flow the precursor material out of the syringe, through the channel 226, and into well 212d. The flow of the precursor material may be stopped when the fill volume 222d is fully occupied by precursor material.

In certain configurations of the channel 226, the second channel opening 226b is configured to receive the needle or the tip of the syringe. For example, second channel opening 226b may have an inner diameter that matches an outer diameter of the needle or the tip. As another example, the second channel opening 226b may include a taper whose diameter decreases when traversing a taper length into the channel 226. At a certain point along the taper length, the taper may have a diameter that matches the outer diameter of the needle or tip. In these cases, the second channel opening 226b may allow the channel 226 to form a contact seal with the syringe, thereby preventing back-flow of the precursor material out of the channel 226.

In many implementations, such as shown in FIG. 2G, the channel 226 is a first channel and the covering body 204 includes a second channel 228. The second channel 228 may allow air (and possibly excess precursor material) to escape from the fill volume 222d as the precursor material flows into the fill volume 222d. Similar to the first channel 226, the second channel 228 may extend between first and second channel opening 228a, 228b. The first channel opening 228a is defined by the covering portion 220d of the mating surface 218, and the second channel opening 228b is defined by the exposed surface 224.

The first and second channels 226, 228 may include respective valves (e.g., respective flap valves) to control a flow of fluid (e.g., the precursor material, air, etc.) into and out of the fill volume 222d. Such control may allow the fill volume 222d to become fully occupied with precursor material without the risk of overfilling the well 212d. In some cases, such as shown in FIG. 2G, the valves are integral to the covering body 204. The valves may include surfaces that are part of the covering portion 220d of the mating surface 218 and thus help to define the fill volume 222d. When the valves are closed, their surfaces may also help to define a surface continuity of the covering portion 220d, thereby ensuring that the fill volume 222d matches the target shape and the target size of its associated attachment.

In some implementations, the first channel 226 includes a first valve 226c that is disposed proximate the first channel opening 226a and configured to open in response to a pressure difference between the first channel 226 and the well 212d. The first valve 226c may open, for instance, when a pressure in the first channel 226 is greater than a pressure in the well 212d. In certain configurations, the first valve 226c is biased to allow a flow of fluid (e.g., the precursor material, a gas such as air, etc.) only along a direction from the first channel 226 and into the well 212d. In some instances, the first valve 226c is a flap valve having one or more flaps that open into the fill volume 222d when the pressure in the first channel 226 is greater than the pressure in the well 212d. However, the flaps remain closed under static conditions, where no pressure difference exists, or reverse conditions, where the pressure in the well 212d is greater than the pressure in the first channel 226. The flap valve may include, for example, include a thin wall that occludes the first channel opening 226a and is partitioned into multiple flaps (e.g., triangular shaped flaps of a circular thin wall). The thin wall may be integral to the covering body 204 and flexible so that each flap can open and close, such as by bending in response to the pressure difference (or changes therein).

In some implementations, the second channel 228 includes a second valve 228c that is disposed proximate the first channel opening 228a of the second channel 228. The second valve 228c is configured to open in response to a pressure difference between the second channel 228 and the well 212d. For instance, the second valve 228c may open when a pressure in the well 212d is greater than a pressure in the second channel 228. In certain configurations, the second valve 228c is biased to allow a flow of fluid (e.g., a gas such as air, the precursor material, etc.) only along a direction from the well 212d and into the first channel 228. In some instances, the second valve 228c is a flap valve having one or more flaps that open into the second channel 228 when the pressure in the well 212d in the well is greater than the pressure in the second channel 228. However, the flaps remain closed under static conditions, where no pressure difference exists, or reverse conditions, where the pressure in the second channel 228 is greater than the pressure in the well 212d.

FIGS. 2A-2G present the covering body 204 as configured in a tray structure with walls that form a U-like cross-section along an arched length of the covering body 204.

However, other configurations are possible for the covering body 204. For example, the covering body 204 may be configured to have a tape or strip structure. FIG. 3A presents a schematic diagram, in perspective view, of an example dental appliance 300 that includes a covering body 304 configured to have a tape structure. The example dental appliance 300 is analogous to the example dental appliance 200 described in relation to FIGS. 2A-2G, and features common to both FIG. 3A and FIGS. 2A-2G are related via coordinated numerals that differ in increment by one hundred. FIG. 3A depicts two instances of the covering body 304a, 304b that cover the wells 312 of the attachment template 302. A first instance 304a covers the two wells 312a, 312b of target recesses 310a, 310b, and a second instance 304b covers the two wells 312c, 312d of target recesses 310c, 310d. However, the covering body 304 may be configured to cover other numbers of wells 312 and at different locations than shown in FIG. 3A.

In some implementations, the covering body 304 includes a tape 340 having first and second tape surfaces 342a, 342b. FIGS. 3B and 3C present schematic diagrams, in respective perspective and side views, of the covering body 304 that show the tape 340. The second tape surface 342b may include the mating surface 318 of the covering body 304. The second tape surface 342b may also include a tape surface covering portion 344 that defines the covering portion 320 of the mating surface 318. FIG. 3C illustrates the tape 340 as having two instances of the tape surface covering portion 344 that are positioned to cover the openings of two respective wells (e.g., the wells 312a, 312b or the wells 312c, 312d). However, other numbers and positions are possible for the tape surface covering portion 344.

In some implementations, the tape surface covering portion 344 may include a non-stick coating to reduce or eliminate an adhesion of the precursor material to the tape surface covering portion 344. In some implementations, the mating surface 318 includes an adhesive coating to allow the tape 340 to better mate (e.g., adhere to) with the recessed surface 306 of the attachment template 302. In these implementations, the adhesive coating may be disposed in a region of the mating surface 318 that excludes the tape surface covering portion 344. The adhesive coating may, in certain configurations, surrounds the tape surface covering portion 344, thereby allowing a seal to be formed around a well that is associated with the tape surface covering portion 344.

FIG. 3D presents a schematic diagram, in cross-section view, of the tape 340 (e.g., the covering body 304a) covering the opening 314b of the well 312b. The mating surface 318 of the tape 340 includes an adhesive coating, which may help to secure the tape 340 to the recessed surface 306 of the attachment template 302. The precursor material 346 fully occupies the fill volume 322b that is associated with well 312b. During manufacture of the example dental appliance 300, the precursor material 346 may be deposited into the well 312b using an amount that matches the fill volume 322b. The second tape surface 342b may then be contacted to the recessed surface 306 of the attachment template 302, thereby allowing tape surface covering portion 344b and the inner well surface 316b to enclose the precursor material 346 in the fill volume 322b.

In some implementations, the tape 340 is opaque to the optical radiation used to produce the composite resin material from the precursor material. For example, the tape 340 may be formed of a material that is opaque to the optical radiation (e.g., a perfluorocarbon material). As another example, the tape 340 may be defined by a series of flexible layers in which one layer (e.g., a middle layer) is formed of a material that is opaque to the optical radiation (e.g., aluminum). In some implementations, such as shown in FIGS. 3A-3C, the tape 340 includes a tab 348 that extends outward from the example dental appliance 300 when the mating surface 318 of the tape 340 mates with the recessed surface 306 of the attachment template 302. The tab 348 may be a pull tab that provides a user of the example dental appliance 300 a protruding feature to pull on when removing the tape 340 from the attachment template 302.

In some implementations, the covering body 304 may be configured to have a tape structure that can cover the exterior surfaces of the attachment template 302, such as by wrapping around all or a portion of the attachment template 302. FIG. 4 presents a schematic diagram, in perspective view, of an example dental appliance 400 in which a covering body 404 is configured to wrap around a pair of target recesses. The example dental appliance 400 is analogous to the example dental appliance 300 described in relation to FIGS. 3A-3D, and features common to both FIG. 4 and FIGS. 3A-3D are related via coordinated numerals that differ in increment by one hundred. FIG. 4 depicts two instances of the covering body 404a, 404b that cover the wells 412 of the attachment template 402. A first instance 404a covers the two wells 412a, 412b of target recesses 410a, 410b, and a second instance 404b covers the two wells 412c, 412d of target recesses 410c, 410d. However, the covering body 404 may be configured to cover other numbers of wells 412 and at different locations than shown in FIG. 4.

In some implementations, the covering body 404 includes a tape surface that contacts all exterior surfaces of the attachment template 402 when contacting the recessed surface 406 of the attachment template 402. In these implementations, the contacted exterior surfaces included the recessed surface 206 of the attachment template 402. In some implementations, such as shown in FIG. 4, the covering body 404 includes a tab 448 that extends outward from the example dental appliance 400 when the mating surface of the covering body 404 mates with the recessed surface 406 of the attachment template 402. In certain cases, the tab 448 may be a pull tab that provides a user of the example dental appliance 400 a protruding feature to pull on when removing the covering body 404 from the attachment template 402. In certain cases, the covering body 404 may include a series of perforations 450 that are spaced along a line, as shown by the dashed line in FIG. 4. In such cases, the series of perforations 450 may be configured to rip or tear the covering body 404 along the line when a user of the example dental appliance 400 pulls on the tab 448. The resulting rip or tear in the covering body 404 may facilitate its removal from the attachment template 402.

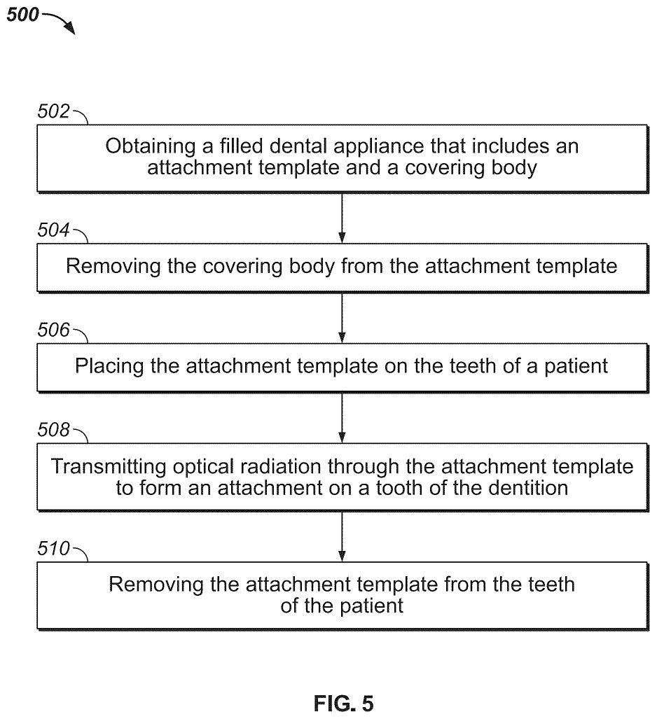

In some implementations, and with reference to FIG. 5, an example dental method 500 may include obtaining a filled dental appliance, as shown by block 502. The filled dental appliance may be analogous to the example dental appliances 200, 300, 400 described in relation to FIGS. 2A-4. For example, the filled dental appliance may include an attachment template and a covering body. The attachment template has a recessed surface that defines recesses in the attachment template that are configured to fit over respective teeth of a patient. Moreover, the respective teeth include a target tooth that is intended to receive an attachment, and the recesses include a target recess that is configured to fit over the target tooth. A well is located in the target recess such that, when the target tooth resides in the target recess, the well resides at a position that matches a target location of the attachment on a surface of the target tooth. The well includes an opening and an inner well surface. The covering body has a mating surface configured to mate with the recessed surface of the attachment template. The mating surface includes a covering portion that covers the opening of the well when the mating surface mates with the recessed surface. The covering portion and the inner well surface enclose a fill volume when the mating surface mates with the recessed surface, and this fill volume matches a target shape and a target size of the attachment. The filled dental appliance additionally includes a precursor material in the well and fully occupying the fill volume. The precursor material is configured to produce a composite resin material when exposed to optical radiation.

The example dental method 500 may also include removing the covering body from the attachment template, as shown by block 504. The example dental method 500 may additionally include placing the attachment template on the teeth of the patient (e.g., a dentition of the patient) to receive teeth into one or more recesses of the attachment template, as shown by block 506. In many implementations, the attachment template is transparent to the optical radiation used to produce the composite resin material. In these implementations, as shown by block 508, the dental method includes transmitting the optical radiation through the attachment template to the precursor material, thereby producing the composite resin material and forming the attachment. The example dental method 500 may then include removing the attachment template from the teeth of the patient, thereby exposing the formed attachments and placing the teeth in a condition to receive a removable aligner device, as shown by block 510.

In some aspects of what is described, a dental appliance may be described by the following examples. The dental appliance may be used for forming attachments on teeth, which may also include positioning the attachments. In many implementations, the attachments are formed from a composite resin material that can be hardened, such as by exposure to optical radiation. In these implementations, the dental appliance is configured to enclose, for each attachment, a respective fill volume for the composite resin material, thereby defining a target shape and size for the attachment.

Example 1. A dental appliance, comprising:
an attachment template configured to be applied to teeth of a patient, the attachment template having a recessed surface that defines:
   recesses configured to fit over respective teeth of the patient, the recesses comprising a target recess that is configured to fit over a target tooth, the target tooth part of the respective teeth and intended to receive an attachment, and
   a well located in the target recess such that, when the target tooth resides in the target recess, the well resides at a position that matches a target location of the attachment on a surface of the target tooth, the well comprising an opening and an inner well surface; and
a covering body having a mating surface that is configured to mate with the recessed surface of the attachment template, the mating surface comprising a covering portion that covers the opening of the well when the mating surface mates with the recessed surface;
wherein the covering portion and the inner well surface enclose a fill volume when the mating surface mates with the recessed surface, the fill volume matching a target shape and a target size of the attachment.

Example 2. The dental appliance of example 1,
wherein the attachment is formed of a composite resin material that is produced by exposing a precursor material to optical radiation; and
wherein the attachment template is transparent to the optical radiation.

Example 3. The dental appliance of example 2, wherein the attachment template comprises a release coating on the inner well surface of the well, the release coating configured to prevent the precursor material from bonding to the attachment template when exposed to the optical radiation.

Example 4. The dental appliance of example 1 or any one of examples 2-3, comprising a precursor material in the well and fully occupying the fill volume, the precursor material configured to produce a composite resin material when exposed to optical radiation.

Example 5. The dental appliance of example 4, wherein the covering body comprises a non-stick coating on the covering portion of the mating surface, the non-stick coating configured to prevent the precursor material from adhering to the covering body.

Example 6. The dental appliance of example 1 or any one of examples 2-5,
wherein the mating surface comprises a contact portion that contacts the recessed surface of the attachment template when the mating surface mates with the recessed surface; and
wherein the covering body comprises an adhesive coating on at least part of the contact portion.

Example 7. The dental appliance of example 1 or any one of examples 2-6, wherein the covering body comprises:
an exposed surface that resides adjacent the fill volume when the mating surface of the covering body mates with the recessed surface of the attachment template; and
a channel that extends between first and second channel openings, the first channel opening defined by the covering portion of the mating surface, the second channel opening defined by the exposed surface.

Example 8. The dental appliance of example 7, wherein the second channel opening is configured to receive a syringe needle or a syringe tip.

Example 9. The dental appliance of example 7 or example 8, wherein the covering body comprises a first valve that is disposed proximate the first channel opening and configured to open in response to a pressure difference between the channel and the well.

Example 10. The dental appliance of example 7 or any one of examples 8-9,
wherein the channel is a first channel;
wherein the covering body comprises a second channel; and
wherein each of the first and second channels extend between respective pairs of first and second channel openings, the first channel openings defined by the covering portion of the mating surface, the second channel openings defined by the exposed surface.

Example 11. The dental appliance of example 10, wherein the covering body comprises a second valve that is disposed proximate the first channel opening of the second channel and configured to open in response to a pressure difference between the second channel and the well.

Example 12. The dental appliance of example 1 or any one of examples 2-6,
wherein the covering body comprises a tape having a tape surface, the tape surface comprising the mating surface of the covering body; and
wherein the tape surface comprises a tape surface covering portion that defines the covering portion of the mating surface.

Example 13. The dental appliance of example 12,
wherein the attachment is formed of a composite resin material that is produced by exposing a precursor material to optical radiation; and
wherein the tape is opaque to the optical radiation.

Example 14. The dental appliance of example 13,
wherein the tape surface contacts all exterior surfaces of the attachment template when contacting the recessed surface of the attachment template; and
wherein the contacted exterior surfaces comprise the recessed surface of the attachment template.

Example 15. The dental appliance of example 1 or any one of examples 11-14, wherein the target location, the target shape, and the target size of the attachment are predetermined based on a model of the dentition of the patient.

Example 16. The dental appliance of example 1 or any one of examples 11-15, wherein covering body comprises a tab that extends outward from the dental appliance when the mating surface of the covering body mates with the recessed surface of the attachment template.

In some aspects of what is described, a dental method may be described by the following examples. The dental method may be used for forming attachments on teeth, which may also include positioning the attachments. In many implementations, the attachments are formed from a composite resin material that can be hardened, such as by exposure to optical radiation. In these implementations, the dental method may use a dental appliance to form the attachments. The dental appliance is configured to enclose, for each attachment, a respective fill volume for the composite resin material, thereby defining a target shape and size for the attachment.

Example 17. A dental method, comprising:
obtaining a filled dental appliance that comprises:
   an attachment template configured to be applied to teeth of a patient, the attachment template having a recessed surface that defines:
      recesses configured to fit over respective teeth of a patient, the recesses comprising a target recess that is configured to fit over a target tooth, the target tooth part of the respective teeth and intended to receive an attachment, and
      a well located in the target recess such that, when the target tooth resides in the target recess, the well resides at a position that matches a target location of the attachment on a surface of the target tooth, the well comprising an opening and an inner well surface,
   a covering body having a mating surface that is mated with the recessed surface of the attachment template, the mating surface comprising a covering portion that covers the opening of the well, the covering portion and the inner well surface enclosing a fill volume that matches a target shape and a target size of the attachment, and
   a precursor material in the well and fully occupying the fill volume, the precursor material configured to produce a composite resin material when exposed to optical radiation;
removing the covering body from the attachment template; and
placing the attachment template on the teeth of the patient to receive the respective teeth into the recesses, thereby contacting the precursor material with the surface of the target tooth at the target location.

Example 18. The dental method of example 17,
wherein the attachment template is transparent to the optical radiation; and
wherein the dental method comprises transmitting the optical radiation through the attachment template to the precursor material, thereby producing the composite resin material and forming the attachment.

Example 19. The dental method of example 17 or example 18, wherein placing the attachment template comprises pressing the well towards the surface of the target tooth, thereby pressing the precursor material against the surface.

Example 20. The dental method of example 17 or any one of examples 18-19, wherein the attachment template comprises a release coating on the inner well surface of the well, the release coating configured to prevent the precursor material from bonding to the attachment template when exposed to the optical radiation.

Example 21. The dental method of example 17 or any one of examples 18-20, wherein the covering body comprises a non-stick coating on the covering portion of the mating surface, the non-stick coating configured to prevent the precursor material from adhering to the covering body.

Example 22. The dental method of example 17 or any one of examples 18-21,
wherein the mating surface comprises a contact portion that contacts the recessed surface of the attachment template when the mating surface mates with the recessed surface; and
wherein the covering body comprises an adhesive coating on at least part of the contact portion.

Example 23. The dental method of example 17 or any one of examples 18-22,
wherein the covering body comprises:
   an exposed surface that resides adjacent the fill volume when the mating surface of the covering body is mated with the recessed surface of the attachment template, and
   a channel that extends between first and second channel openings, the first channel opening defined by the covering portion of the mating surface, the second channel opening defined by the exposed surface; and
wherein obtaining the filled dental appliance comprises flowing the precursor material through the channel and into the well, thereby fully occupying the fill volume with the precursor material.

Example 24. The dental method of example 23,
wherein the second channel opening is configured to receive a syringe needle or a syringe tip; and
wherein flowing the precursor material comprises:
   inserting the syringe needle or the syringe tip into the second channel opening, the syringe needle or the syringe tip coupled to a syringe that contains the precursor material, and
   displacing a plunger of the syringe to displace the precursor material out of the syringe and into the channel.

Example 25. The dental method of example 23 or example 24,
wherein the covering body comprises a first valve that is disposed proximate the first channel opening and configured to open in response to a pressure difference between the channel and the well; and
wherein flowing the precursor material comprises generating a pressure in the channel that is greater than a pressure in the well.

Example 26. The dental method of example 23 or any one of examples 24-25,
wherein the channel is a first channel;
wherein the covering body comprises a second channel;
wherein each of the first and second channels extend between respective pairs of first and second channel openings, the first channel openings defined by the covering portion of the mating surface, the second channel openings defined by the exposed surface; and
wherein flowing the precursor material comprises discharging gas from the well and into the second channel in response to the precursor material flowing into the well.

Example 27. The dental method of example 26,
wherein the covering body comprises a second valve that is disposed proximate the first channel opening of the second channel and configured to open in response to a pressure difference between the well and the second channel; and
wherein flowing the precursor material comprises generating a pressure in the well that is greater than a pressure in the second channel.

Example 28. The dental method of example 17 or any one of examples 18-22,
wherein the covering body comprises a tape having a tape surface, the tape surface comprising the mating surface of the covering body; and
wherein the tape surface comprises a tape surface covering portion that defines the covering portion of the mating surface.

Example 29. The dental method of example 28, wherein the tape is opaque to the optical radiation.

Example 30. The dental method of example 28 or example 29, wherein obtaining the filled dental appliance comprises:
disposing the precursor material into the well; and
contacting the tape surface of the tape with the recessed surface of the attachment template, the tape surface covering portion covering the opening of the well.

Example 31. The dental method of example 30,
wherein the contacting the tape surface of the tape comprises contacting the tape surface with all exterior surfaces of the attachment template; and
wherein the contacted exterior surfaces comprise the recessed surface of the attachment template.

Example 32. The dental method of example 17 or any one of examples 18-31, comprising:
generating, by operation of a computer, a model of the dentition of the patient based on profilometry data that represents one or more surfaces of the dentition; and
determining, by operation of the computer, the target location, the target shape, and the target size of the attachment based on the model.

Example 33. The dental method of example 17 or any one of examples 18-32,
wherein covering body comprises a tab that extends outward from the filled dental appliance when the mating surface of the covering body is mated with the recessed surface of the attachment template; and
wherein removing the covering body comprises pulling the tab to displace the covering body away from the attachment template.

While this specification contains many details, these should not be understood as limitations on the scope of what may be claimed, but rather as descriptions of features specific to particular examples. Certain features that are described in this specification or shown in the drawings in the context of separate implementations can also be combined. Conversely, various features that are described or shown in the context of a single implementation can also be implemented in multiple embodiments separately or in any suitable subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single product or packaged into multiple products.

A number of embodiments have been described. Nevertheless, it will be understood that various modifications can be made. Accordingly, other embodiments are within the scope of the following claims.

1. A dental appliance, comprising:
an attachment template configured to be applied to teeth of a patient, the attachment template having a recessed surface that defines:
recesses configured to fit over respective teeth of the patient, the recesses comprising a target recess that is configured to fit over a target tooth, the target tooth part of the respective teeth and intended to receive an attachment, and a well located in the target recess such that, when the target tooth resides in the target recess, the well resides at a position that matches a target location of the attachment on a surface of the target tooth, the well comprising an opening and an inner well surface; and
a covering body having a mating surface that is configured to mate with the recessed surface of the attachment template, the mating surface comprising a covering portion that covers the opening of the well when the mating surface mates with the recessed surface;
wherein the covering portion and the inner well surface enclose a fill volume when the mating surface mates with the recessed surface, the fill volume corresponding to a target
shape and a target size of the attachment.

2. The dental appliance of claim 1, wherein the attachment is formed of a composite resin material that is produced by exposing a precursor material to optical radiation; and
wherein the attachment template is transparent to the optical radiation.

3. The dental appliance of claim 2, wherein the attachment template comprises a release coating on the inner well surface of the well, the release coating configured to prevent the precursor material from bonding to the attachment template when exposed to the optical radiation.

4. The dental appliance of claim 1, comprising a precursor material in the well and occupying the fill volume, the precursor material configured to produce a composite resin material when exposed to optical radiation.

5. The dental appliance of claim 4, wherein the covering body comprises a non-stick coating on the covering portion of the mating surface, the non-stick coating configured to prevent the precursor material from adhering to the covering body.

6. The dental appliance of claim 1, wherein the mating surface comprises a contact portion that contacts the recessed surface of the attachment template when the mating surface mates with the recessed surface; and
wherein the covering body comprises an adhesive coating on at least part of the contact portion.

7. The dental appliance of claim 1, wherein the covering body comprises:
an exposed surface that resides adjacent the fill volume when the mating surface of the covering body mates with the recessed surface of the attachment template; and
a channel that extends between first and second channel openings, the first channel opening defined by the covering portion of the mating surface, the second channel opening defined by the exposed surface.

8. The dental appliance of claim 7, wherein the channel is a first channel;
wherein the covering body comprises a second channel; and
wherein each of the first and second channels extend between respective pairs of first and second channel openings, the first channel openings defined by the covering portion of the mating surface, the second channel openings defined by the exposed surface.

9. The dental appliance of claim 1, wherein the covering body comprises a tape having a tape surface, the tape surface comprising the mating surface of the covering body; and
wherein the tape surface comprises a tape surface covering portion that defines the covering portion of the mating surface.

10. The dental appliance of claim 9, wherein the attachment is formed of a composite resin material that is produced by exposing a precursor material to optical radiation; and
wherein the tape is opaque to the optical radiation.

11. A dental method, comprising:
obtaining a filled dental appliance that comprises:
an attachment template configured to be applied to teeth of a patient, the attachment template having a recessed surface that defines:
recesses configured to fit over respective teeth of a patient, the recesses comprising a target recess that is configured to fit over a target tooth, the target tooth part of the respective teeth and intended to receive an attachment, and
a well located in the target recess such that, when the target tooth resides in the target recess, the well resides at a position that matches a target location of the attachment on a surface of the target tooth, the well comprising an opening and an inner well surface, a covering body having a mating surface that is mated with the recessed surface of the attachment template, the mating surface comprising a covering portion that covers the opening of the well, the covering portion and the inner well surface enclosing a fill volume that corresponds to a target shape and a target size of the attachment, and a precursor material in the well and occupying the fill volume, the precursor material configured to produce a composite resin material when exposed to optical radiation;
removing the covering body from the attachment template; and
placing the attachment template on the teeth of the patient to receive the respective teeth into the recesses, thereby contacting the precursor material with the surface of the target tooth at the target location.

12. The dental method of claim 11, wherein the attachment template is transparent to the optical radiation; and
wherein the dental method comprises transmitting the optical radiation through the attachment template to the precursor material, thereby producing the composite resin material and forming the attachment.

13. The dental method of claim 11, wherein the covering body comprises:
an exposed surface that resides adjacent the fill volume when the mating surface of the covering body is mated with the recessed surface of the attachment template, and
a channel that extends between first and second channel openings, the first channel opening defined by the covering portion of the mating surface, the second channel opening defined by the exposed surface; and
wherein obtaining the filled dental appliance comprises flowing the precursor material through the channel and into the well, thereby fully occupying the fill volume with the precursor material.

14. The dental method of claim 13, wherein the second channel opening is configured to receive a syringe needle or a syringe tip;
and wherein flowing the precursor material comprises:
inserting the syringe needle or the syringe tip into the second channel opening, the syringe needle or the syringe tip coupled to a syringe that contains the precursor material, and
displacing a plunger of the syringe to displace the precursor material out of the syringe and into the channel.

15. The dental method of claim 13, wherein the covering body comprises a first valve that is disposed proximate the first channel opening and configured to open in response to a pressure difference between the channel and the well; and
wherein flowing the precursor material comprises generating a pressure in the channel that is greater than a pressure in the well.

16. The dental method of claim 13, wherein the channel is a first channel;
wherein the covering body comprises a second channel;
wherein each of the first and second channels extend between respective pairs of first and second channel openings, the first channel openings defined by the covering portion of the mating surface, the second channel openings defined by the exposed surface; and
wherein flowing the precursor material comprises discharging gas from the well and into the second channel in response to the precursor material flowing into the well.

17. The dental method of claim 11, wherein the covering body comprises a tape having a tape surface, the tape surface comprising the mating surface of the covering body; and
wherein the tape surface comprises a tape surface covering portion that defines the covering portion of the mating surface.

18. The dental method of claim 17, wherein the tape is opaque to the optical radiation.

19. The dental method of claim 17, wherein obtaining the filled dental appliance comprises:
disposing the precursor material into the well; and
contacting the tape surface of the tape with the recessed surface of the attachment template, the tape surface covering portion covering the opening of the well.

20. The dental method of claim 11, wherein covering body comprises a tab that extends outward from the filled dental appliance when the mating surface of the covering body is mated with the recessed surface of the attachment template; and
wherein removing the covering body comprises pulling the tab to displace the covering body away from the attachment template.
